(19) United States
(12) Patent Application Publication
(10) Pub. No.: US 2021/0348544 A1
(43) Pub. Date: Nov. 11, 2021

(54) Pre-Chamber Spark Plug for a Combustion Chamber of an Internal Combustion Engine, in Particular of a Motor Vehicle

(71) Applicant: Daimler AG, Stuttgart (DE)

(72) Inventor: Werner HOLLY, Stuttgart (DE)

(73) Assignee: Daimler AG, Stuttgart (DE)

(21) Appl. No.: 17/273,168

(22) PCT Filed: Aug. 21, 2019
(86) PCT No.: PCT/EP2019/072314

§ 371 Date: Mar. 3, 2021

(30) Foreign Application Priority Data
Sep. 7, 2018 (DE) 10 2018 007 093.0

(51) Int. Cl. F02B 19/12; F02B 19/18

(52) U.S. Cl. CPC F02B 19/12; F02B 19/18

(57) ABSTRACT

A pre-chamber spark plug for a combustion chamber of an internal combustion engine includes a pre-chamber with a plurality of openings where the pre-chamber is fluidically connectable to the combustion chamber via the plurality of openings. The plurality of openings are configured to cause a tumbling flow of a fuel/air mixture flowing into the pre-chamber from the combustion chamber via the plurality of openings. At least two of the openings of the plurality of openings have diameters which differ from one another. At least two of the openings of the plurality of openings enclose angles from a main axis of the pre-chamber which differ from one another.

### BACKGROUND AND SUMMARY OF THE INVENTION

The invention relates to a pre-chamber spark plug for a combustion chamber of an internal combustion engine, in particular of a motor vehicle.

Such a pre-chamber spark plug for a combustion chamber of an internal combustion engine, in particular of a motor vehicle, is already known, for example, from DE 29 16 285 A1. The pre-chamber spark plug has a pre-chamber with a plurality of openings in the form of through-openings, such that the pre-chamber can be fluidically connected via the openings to the combustion chamber, which is designed, for example, as a cylinder or is formed by a cylinder. A fuel-air mixture can be introduced from the combustion chamber into the pre-chamber via the openings, such that the fuel-air mixture introduced into the pre-chamber, for example, can be ignited in the pre-chamber.

Furthermore, JP 2010096089 A discloses a spark plug for an internal combustion engine.

The object of the present invention is to improve a pre-chamber spark plug of the type mentioned above.

In order to improve a pre-chamber spark plug of the type indicated herein, it is provided in accordance with the invention that the openings are designed to bring about a tumbling flow of the fuel-air mixture flowing into the pre-chamber via the openings. In other words, during fired operation of the internal combustion engine, the openings cause, for example by their arrangement and/or their number and/or their geometry, a tumbling flow of the fuel-air mixture, which is simply also referred to as a mixture, flowing through the openings and thereby flowing out of the combustion chamber into the pre-chamber. Expressed again in other words, the openings, which are formed for example as through-openings, imprint on the mixture flowing through the openings and thereby flowing out of the combustion chamber into the pre-chamber an at least substantially tumbling and thus cylindrical flow, also referred to as tumble flow, such that a particularly advantageous operation of the pre-chamber spark plug and thus of the internal combustion engine as a whole can be implemented. In contrast to a swirl-shaped flow, which extends, for example, helically around a main axis or around a longitudinal axis of the pre-chamber, the tumbling flow is a cylindrical flow, also known as a roller flow, which extends, for example, at least partially in a plane or runs in a plane in which the main axis lies.

The tumbling flow, also referred to as tumble flow, positively influences the combustion in the pre-chamber in several ways, which means that a particularly large working area can be implemented in the pre-chamber. Firstly, there is better flushing of the residual gas in the spark plug gap area, resulting in more stable ignition. Compared with conventional spark plugs, there is more favorable convection of the initial flame core in the direction of the openings, which are also referred to as nozzles or are designed as nozzles. As a result of the improved flushing and due to the more favorable convection, a more combustion-friendly design of the electrode of the spark plug can be achieved, in particular with regard to a lower penetration depth of the ground electrode. This results in a smaller surface area, which in turn results in lower wall heat losses. As a result, the tendency to pre-ignition can be reduced compared with conventional pre-chamber spark plugs.

In conventional pre-chamber spark plugs, the openings cause an at least substantially swirling flow of the mixture flowing through the opening and thus from the combustion chamber into the pre-chamber, in particular due to their symmetrical or uniform arrangement. The disadvantage of this is that lower turbulence intensities of the pre-chamber are achieved and the initial flame core is not convected or is convected away from the openings, which are also referred to as pre-chamber nozzles.

To ensure sufficiently low residual gas contents in the area of the spark plug gap in conventional pre-chamber spark plugs, a long electrode must be used which projects deep into the pre-chamber. This results in a fissured surface in the pre-chamber and a large volume of damage. The previously mentioned problems and disadvantages can be avoided with the pre-chamber spark plug according to the invention.

The nozzles differ in their diameters. To improve the tumble flow, at least two of the openings include two angles, which are different from each other, with the main axis of the pre-chamber. In particular, the angle is an angle between the main axis and a respective axis of the opening.

In addition, the tumble flow is further improved by a corresponding number of the openings and/or a corresponding distribution of the nozzles around the main axis, wherein the openings are arranged around the main axis of the pre-chamber in a non-uniform or non-symmetrical or asymmetrical distribution.

The combustion in the pre-chamber is stabilized and improved by the tumble flow. As a result, the working area of the pre-chamber is enlarged, such that more stable ignition when idle and a lower risk of pre-ignition at full load can be implemented. Furthermore, the improved combustion results in a greater pressure rise in the pre-chamber and consequently a deeper flare penetration depth into the combustion chamber. This also improves combustion in the main combustion chamber. The flare penetration depth is understood to be a distance or a depth which respective flares penetrate into the pre-chamber. The respective flare results from the mixture being ignited and subsequently combusted in the pre-chamber.

Further advantages, features and details of the invention arise from the following description of a preferred exemplary embodiment and from the drawings. The features and combinations of features mentioned above in the description and the features and combinations of features mentioned below in the description of figures and/or shown in the figures alone can be used not only in the combination indicated in each case, but also in other combinations or on their own, without leaving the scope of the invention.

### BRIEF DESCRIPTION OF THE DRAWINGS

FIG. 1 is a schematic and sectional side view of a pre-chamber spark plug according to the invention for a combustion chamber of an internal combustion engine of a motor vehicle;

FIG. 2 is a further schematic and sectional side view of the pre-chamber spark plug; and

FIG. 3 is a schematic depiction of the pre-chamber spark plug according to a view denoted as A in FIG. 2.

### DETAILED DESCRIPTION OF THE DRAWINGS

Identical or functionally identical elements are provided with identical reference numerals in the figures.

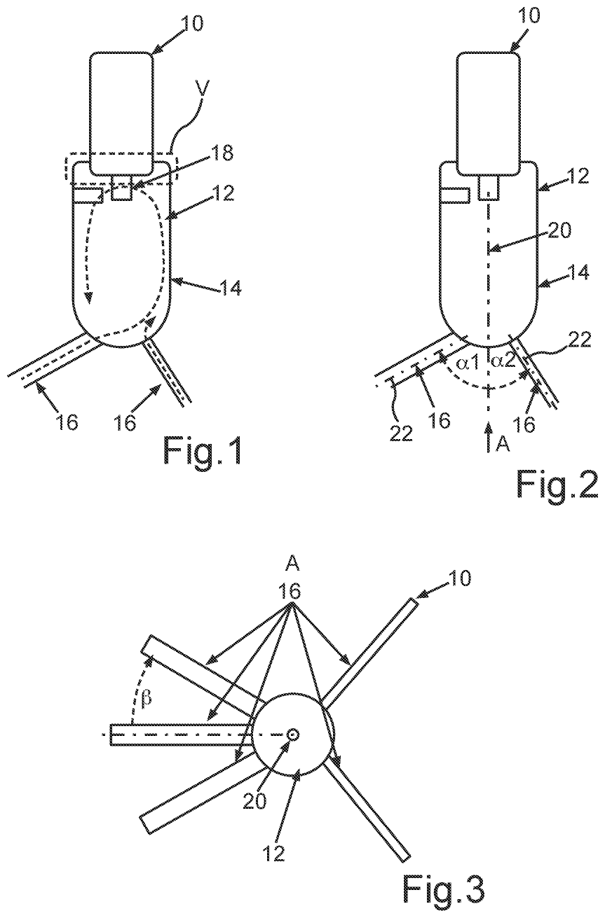

FIGS. 1 and 2 each show a schematic and sectional side view of a pre-chamber spark plug 10 for a combustion chamber formed, for example, by a cylinder or designed as a cylinder of an internal combustion engine, for example designed as a reciprocating engine, of a motor vehicle, in particular a motor vehicle such as, for example, a passenger car. The motor vehicle can be driven by means of the internal combustion engine. The pre-chamber spark plug 10 has at least or exactly one pre-chamber 12, the contour of which is designated 14 in FIG. 1. The pre-chamber 12 has a plurality of openings 16, also referred to as nozzles and designed as through-openings, via which the pre-chamber 12 can be fluidically connected to the combustion chamber. In its fully manufactured state, the internal combustion engine has the aforementioned combustion chamber and the pre-chamber spark plug 10, such that in the fully manufactured state of the internal combustion engine, the pre-chamber spark plug 12 is fluidically connected to the combustion chamber via the openings 16. This allows a fuel-air mixture from the combustion chamber to flow at least partially through the openings 16 and thereby into the pre-chamber 12, such that at least part of the fuel-air mixture, which is simply also referred to as a mixture, flows from the combustion chamber and the openings 16 into the pre-chamber 12.

The pre-chamber spark plug 10 has at least one or more electrodes in this case, wherein one of the electrodes of the pre-chamber spark plug 10 designated 18 is identifiable in FIG. 1. The electrode 18 is designed, for example, as a ground electrode. By means of the electrode 18, at least one ignition spark can be provided in the pre-chamber 12. By means of the ignition spark, the mixture which has flowed into the pre-chamber 12 via the openings 16 is ignited. This results in flares which flow through the openings 16 and thus flow out of the pre-chamber 12 into the combustion chamber via the openings 16. This ignites, for example, a further portion of the fuel-air mixture remaining in the combustion chamber.

In order to be able to implement a particularly advantageous operation of the pre-chamber spark plug 10 and thus of the internal combustion engine as a whole, the openings 16 are designed to bring about a tumbling flow of the mixture flowing into the pre-chamber 12 via the openings 16, which is depicted by arrows in FIG. 1 and is also referred to as a roller-shaped flow or roller flow. In particular, the arrows shown in FIG. 1 illustrate a contour of the tumbling flow, also referred to as a flow contour.

In FIG. 2, a main axis of the pre-chamber 12 is designated 20. The main axis 20 runs in a plane, around the plane normal of which the tumbling flow runs. Due to the tumbling flow, a volume V of the pre-chamber 12, also referred to as the damage volume, can be kept particularly low, such that a particularly large working range of the pre-chamber 12 can be guaranteed. In FIG. 2, respective axes of the respective openings 16 are designated 22. The respective axis 22 coincides with a direction of passage along which the mixture from the combustion chamber can flow through the respective opening 16 and thus flow into the pre-chamber 12. In addition, the respective flare resulting from ignition of the portion of the mixture in the pre-chamber 12 can flow through the respective opening 16 and thus flow from the pre-chamber 12 into the combustion chamber. It can be seen from FIG. 2 that the respective axis 22, and thus the respective opening 16, encloses an angle α1 or α2 with the main axis 20. In order to cause the tumbling flow, for example, the angles α1 and α2 differ.

In addition, for example, a first of the openings 16 has a first diameter through which the mixture can flow, wherein a second of the openings 16 has a second diameter through which the mixture can flow, which is different from the first diameter. Thus, for example, different diameters of the nozzles and/or different angles α1 and α2 are provided.

It can be seen from FIG. 3 that, alternatively or additionally, it can be provided that the openings 16 can be arranged unevenly or asymmetrically distributed around the main axis 20. The tumbling flow is thus caused, for example, by the different diameters and/or by the different angles α1 and α2 and/or around the distribution of the openings 16 around the main axis 20 and/or by a corresponding number of the openings 16. In FIG. 3, β denotes an angle which, for example, two of the axes 22 enclose with each other.

### LIST OF REFERENCE CHARACTERS

10 pre-chamber spark plug
12 pre-chamber
14 contour
16 openings
18 electrode
20 main axis
22 axis
α1, α2 angle
β angle
V volume

1.-2. (canceled)

3. A pre-chamber spark plug for a combustion chamber of an internal combustion engine, comprising:
a pre-chamber, wherein the pre-chamber has a plurality of openings and wherein the pre-chamber is fluidically connectable to the combustion chamber via the plurality of openings;
wherein the plurality of openings are configured to cause a tumbling flow of a fuel/air mixture flowing into the pre-chamber from the combustion chamber via the plurality of openings;
wherein at least two of the openings of the plurality of openings have diameters which differ from one another;
wherein at least two of the openings of the plurality of openings enclose angles from a main axis of the pre-chamber which differ from one another.

4. The pre-chamber spark plug according to claim 3, wherein the plurality of openings are disposed asymmetrically around the main axis.

5. A method for igniting a fuel/air mixture in a pre-chamber spark plug of a combustion chamber of an internal combustion engine, wherein the pre-chamber spark plug has a pre-chamber with a plurality of openings, comprising the steps of:
causing a tumbling flow of a fuel/air mixture flowing into the pre-chamber from the combustion chamber via the plurality of openings; and
igniting the fuel/air mixture in the pre-chamber.

6. The method according to claim 5, wherein at least two of the openings of the plurality of openings have diameters which differ from one another.

7. The method according to claim 5, wherein at least two of the openings of the plurality of openings enclose angles from a main axis of the pre-chamber which differ from one another.

8. The method according to claim 5, wherein the plurality of openings are disposed asymmetrically around a main axis of the pre-chamber.
